(19) United States
(12) Patent Application Publication
(10) Pub. No.: US 2008/0259341 A1
(43) Pub. Date: Oct. 23, 2008

(54) METHOD AND APPARATUS FOR OPTICALLY READING GAS SAMPLING TEST CARDS

(76) Inventors: Gary W. Short, Glendale, CA (US); Dale Main, La Canada, CA (US); Margaret R. Pippin, Yorktown, VA (US); Linda Bush, Lawrence, KS (US)

Correspondence Address: SUGHRUE MION, PLLC, 2100 PENNSYLVANIA AVENUE, N.W., SUITE 800, WASHINGTON, DC, 20037, US

(21) Appl. No.: 11/935,881

(22) Filed: Nov. 6, 2007

Related U.S. Application Data
(60) Provisional application No. 60/864,670, filed on Nov. 7, 2006.

(51) Int. Cl. G01N 21/84

(52) U.S. Cl. 356/437

(57) ABSTRACT

A method and apparatus for measuring a gas concentration detected by a passive sampler are provided. The apparatus includes a light source which illuminates a passive sampler, a detector which detects light from the light source reflected from the passive sampler and provides an output signal, and a microprocessor which receives the output signal and calculates light absorption by the passive sampler based on the received signal.

### CROSS REFERENCE TO RELATED APPLICATIONS

This application claims priority from U.S. Provisional Application No. 60/864,670 filed on Nov. 7, 2006 in the United States Patent and Trademark Office, the disclosure of which is incorporated herein in its entirety by reference.

### BACKGROUND OF THE INVENTION

1. Field of the Invention

The present invention is related to determining the concentrations of gases detected by passive samplers for gas detection, and more particularly to a method and apparatus for optically reading passive samplers using an absorption method to determine the concentrations of detected gases.

2. Description of the Related Art

Ozone is deleterious to materials and to humans. The Occupational Safety and Health Administration (OSHA) limits for average ozone concentration are up to 0.1 parts-per-million (ppm) during an eight-hour period or up to 0.3 ppm over a fifteen-minute period. Presently, there are a number techniques for measuring atmospheric ozone concentration using various instruments ranging from electronic sensors to expensive monitoring stations.

Ozone detectors which operate on the basis of ultraviolet light absorption can detect ozone levels as low as about 0.001 ppm but have the disadvantage of being large and heavy. These detectors can have typical dimensions of about nineteen inches by 12 inches by 6.5 inches and weigh about twenty-two pounds. Further, they are stationary instruments requiring full line voltage of 115 VAC and a warm-up time of about 2 hours. These detectors are also expensive, with cost ranging about $4,500-$12,000 per detector. In short, such detectors are sensitive, expensive and intended for stationary laboratory use.

The fact that a detector must remain in the lab is a serious disadvantage because gas concentrations often need to be measured in widely separated locations, for example when determining an average gas concentration over an entire city or measuring the ambient gas concentrations in every room in a building.

Furthermore, a critical disadvantage of an absorption ozone detector resides in the fact that ozone is very chemically active and thus easily destroyed inside many containers. Therefore, sample collection for later analysis is precluded.

Environmental gas concentrations can also depend on the time of day a sample is taken. For example, on a summer day, ozone concentration in the ambient air at about the ground level is about 0.08 ppm, whereas at night the ozone concentration drops to about 0.02 ppm. In winter, the daytime ozone concentration is about 0.03 ppm, whereas at night it drops to about 0.02 ppm. In some locations, for example in Los Angeles, ozone concentrations exceed these values. For instance, on a summer day in Los Angeles, ozone daytime concentration often exceeds 0.10 ppm, whereas at night it is about 0.02 ppm.

Passive samplers are also known in the industry. A passive sampler is a piece of chemically treated filter paper that changes color when exposed to ozone or other specified gases depending on the chemical formulation or treatment of the filter paper. The color change of the filter paper is then measured by comparison of the exposed filter paper to colormetric charts or strips to determine the level of ozone or other specified gas exposure.

However, while portable, colormetric charts and strips provide only a subjective determination of gas concentration and fail to account for many variables that affect the accuracy of the reading obtained from the passive samplers. For example, wind speed, temperature and humidity can alter the accuracy of the reading. Therefore, given the subjective nature of matching test card colors to a color chart and the unaccounted for variables that can affect the test reading, only imprecise measurements of gas concentrations result.

What is needed is an optical reader for passive samplers that provides increased accuracy in determining the concentration of gases detected by passive samplers by accounting for variables that affect the accuracy of the readings.

### SUMMARY OF THE INVENTION

Illustrative, non-limiting embodiments of the present invention overcome the above disadvantages and other disadvantages not described above. It will be appreciated, of course, that overcoming the general problems mentioned is not a requirement and that various implementations will fall within the scope and spirit of the invention regardless.

A hand held, battery powered device that measures reflected light intensity of passive samplers which changes color after exposure to a specific gas is provided. By detecting the intensity of the light reflected from an exposed passive sampler and comparing it to the intensity of the light reflected from an unexposed passive sampler, it is possible to calculate the percentage of light absorbed by the exposed passive sampler and correlate the percentage of absorbed light to the concentration level of the targeted gas in the surrounding air.

An aspect of the present invention provides an apparatus for measuring and recording data related to concentrations of atmospheric gases existing at multiple sites where the atmospheric gas concentrations are detected using passive samplers.

Another aspect of the present invention provides means for measuring and storing data related to environmental conditions obtained at multiple sites.

A further aspect of the present invention provides means for determining geographic locations where gas concentrations and/or environmental data are measured.

A still further aspect of the present invention provides means for transmitting the measured and/or stored data to other locations.

A still further aspect of the present invention provides a method of measuring, storing and wirelessly transmitting and/or receiving data related to atmospheric gases and environmental conditions obtained at multiple sites.

A still further aspect of the present invention provides a computer-readable medium having stored therein a program for making a computer execute a method of measuring, storing and transmitting and/or receiving data related to atmospheric gases and environmental conditions obtained at multiple sites.

### BRIEF DESCRIPTION OF THE DRAWINGS

The above and other aspects of the present invention will become more apparent by describing in detail exemplary embodiments thereof with reference to the attached drawings in which:

FIG. 1 is block diagram illustrating a non-limiting exemplary embodiment of the present invention;

FIG. 2 is block diagram illustrating a passive sampler reader in more detail; and

FIG. 3 is a flowchart illustrating the sequence for measuring and displaying the results of a gas concentration measurement according to a non-limiting exemplary embodiment of the present invention.

### DETAILED DESCRIPTION OF THE EXEMPLARY EMBODIMENTS

Exemplary embodiments of the present invention provide a hand held, battery powered device designed to measure the light intensity of passive samplers, i.e., chemically treated filter paper, which changes color after exposure to a specific gas. By comparing the detected intensity of light reflected from an exposed passive sampler to the detected intensity of light reflected from an unexposed passive sampler, the percentage of light absorbed by the exposed passive sampler can be correlated to the concentration of a specific gas in the surrounding air.

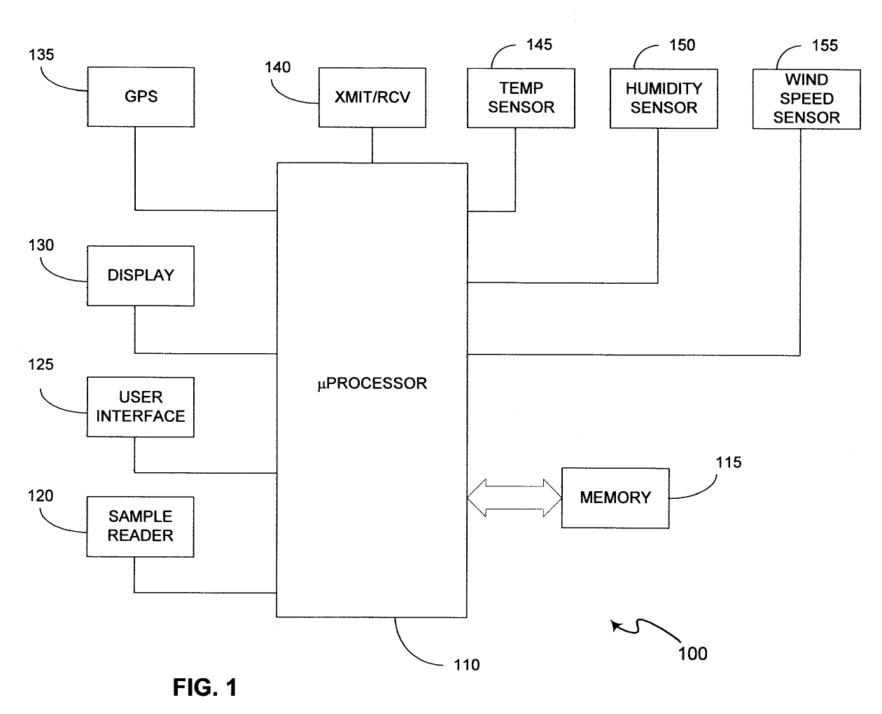

FIG. 1 is block diagram illustrating a non-limiting exemplary embodiment of the present invention. As illustrated in FIG. 1, a microprocessor 110 receives input from a passive sampler reader 120, and from one or more auxiliary sensors, for example, but not limited to, a temperature sensor 145, a humidity sensor 150 and a wind speed sensor 155.

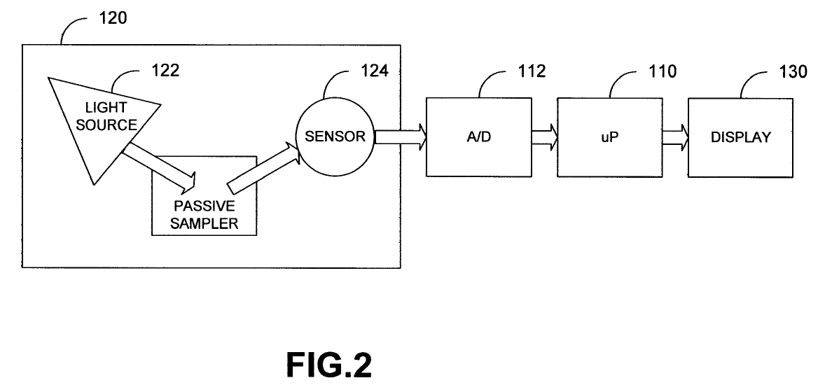

FIG. 2 is block diagram illustrating a passive sampler reader in more detail. The passive sampler reader 120 illuminates an exposed passive sampler using a light source 122 and detects the intensity of light reflected from the passive sampler with a sensor 124. The light source 122 may be, for example, but not limited to, at least one light emitting diode (LED). The LED may emit light having a wavelength of about 565 nm, but is not limited to this wavelength. LEDs having different wavelengths may be used with alternate passive samplers for use with various gases. The passive sampler reader 120 may detect the reflected light intensity with a sensor 124, for example, but not limited to, a photodetector.

An analog-to-digital converter (A/D) 112 converts a detected light intensity signal from the sensor 124 into digital form usable by the microprocessor 110. The microprocessor 110 calculates a percentage of light absorbed by the exposed passive sampler based on a difference between the reflected light intensity of the exposed passive sampler and the reflected light intensity of an unexposed passive sampler. The percentage of absorbed light can then be correlated to a concentration of a specific gas detected by the passive sampler. Ultraviolet light absorption is a technique that takes advantage of absorption spectra of specific gases. For example, ozone has a 254 nm absorption line in the electromagnetic spectra and that can be used to measure the concentration of ozone.

The microprocessor may use signals received from one or more auxiliary sensors, for example, but not limited to, the temperature sensor 145, humidity sensor 150 and wind speed sensor 155 to enhance the accuracy of the percentage of absorbed light calculation.

A GPS system 135 may detect the geographic position of the apparatus to pinpoint the location where an exposed passive sampler measurement is performed. The location information and other test and environmental data may be stored in a memory 115. A transmitter/receiver 140 transmits data between the apparatus and one or more remote locations and/or databases. For example, the apparatus may transmit data to a central location where a database is maintained. The transmitter/receiver 140 may also receive GPS information.

A user interface device 125 and a display 130 allow a user to control operation of the apparatus, for example, but not limited to, performing a white card (i.e., unexposed passive sampler) calibration procedure and inputting test-related data, and displaying test results, related data and informational messages. In addition, units of measurement, for example, but not limited to PPB, PPM, AQI and metric units, may be input and displayed.

In operation, a white card calibration procedure may be performed in which a baseline reflected light intensity measurement is acquired by illuminating an unexposed passive sampler and measuring the reflected light intensity. This baseline measurement may be used in calculating percentage absorbance of a specific gas by an exposed passive sampler. The white card calibration procedure may be performed once and the resulting measurement used to calculate percentage absorbance of a specific gas from the reflected light intensity measurements of a number of exposed passive samplers, for example, ten passive samplers, before again performing the white card calibration procedure. Alternatively, the white card calibration procedure may be performed prior to the reflected light intensity measurement of each exposed passive sampler.

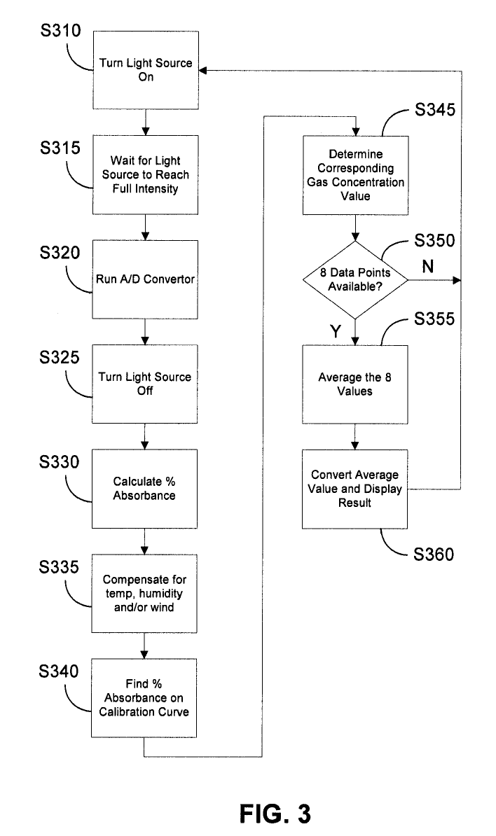

FIG. 3 is a flowchart illustrating the sequence for measuring and displaying the results of a gas concentration measurement according to a non-limiting exemplary embodiment of the present invention. The light source is turned on (S310) and allowed to reach full intensity (S315). A number of reflected light intensity readings from the output of the photodetector, for example, but not limited to, ten, are taken by an analog-to-digital converter (S320). The light source is then turned off (S325). The microprocessor calculates the percent (%) absorbance based on the analog-to-digital converter readings (S330). The percent (%) absorbance value may be compensated by, for example, but not limited to, temperature, humidity and/or wind speed parameters (S335). The calculated value is correlated with a calibration curve (S340) to determine a corresponding gas concentration value (S345). If eight data points are available (S350), their values are averaged (S355) and the average value converted to an appropriate format and displayed on the display (S360). The algorithm is further described below using ozone (OZ) as an example.

The algorithm is a segmented linear curve fit between each set of adjacent data points in the OZ versus % ABS calibration table. The A/D converter reading is subtracted from the peak raw white card reading obtained in “CALIB” mode (i.e., white card calibration) in order to obtain the number of A/D counts from the maximum possible A/D counts. ABS is converted to % ABS.

Additional parameters, for example, but not limited to, temperature, humidity and/or wind speed parameters may be used in several ways to enhance the accuracy of the reading. Where a parameter shifts a calibration curve up or down without changing the shape of the curve, the parameter may be added or subtracted from the % ABS. Where a parameter changes the slope of the calibration curve, the % ABS may be multiplied or divided by the parameter. Where the parameters affect the gas concentration measurement independent of each other, the effects of the parameters may be calculated after the averaging operation. If the parameters are not independent, a calculation may be performed inside the loop after the % ABS is calculated.

The normalized % ABS value is used in the linear curve fit. In the case of more complex interactions of the parameters, an equation may be used to directly calculate the ozone from the % ABS and the parameters. The output value is capped at the OZ value of the last calibration point. Eight OZ values are accumulated and averaged. The average OZ value is then displayed.

Exemplary embodiments of the present invention may also provide a computer-readable medium having stored therein a program for making a computer execute a method of measuring, storing and transmitting and/or receiving data related to atmospheric gases and environmental conditions obtained at multiple sites as set forth above.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. An apparatus for measuring a gas concentration detected by a passive sampler, the apparatus comprising:
a light source which illuminates a passive sampler;
a detector which detects light from the light source reflected from the passive sampler and provides an output signal; and
a microprocessor which receives the output signal and calculates light absorption by the passive sampler based on the received signal.

2. The apparatus of claim 1, wherein the apparatus is a handheld apparatus.

3. The apparatus of claim 1, wherein the apparatus is a battery-powered apparatus.

4. The apparatus of claim 1, wherein the light source is a light emitting diode.

5. The apparatus of claim 1, further comprising at least one of a temperature sensor, a humidity sensor, and a wind speed sensor.

6. The apparatus of claim 5, wherein the microprocessor receives at least one of the detected light intensity signal, the detected temperature signal, the humidity signal and the detected wind speed signal, and calculates light absorption by the passive sampler based on the detected light intensity signal and at least one of the other received signals.

7. The apparatus of claim 5, further comprising a global positioning system (GPS) which determines a geographical location of the apparatus.

8. The apparatus of claim 7, further comprising a memory which stores data related to at least one of detected light intensity, detected temperature, detected humidity, detected wind speed, geographical location.

9. The apparatus of claim 8, further comprising a transmitter/receiver which transmits/receives data to/from a remote location.

10. A method of measuring a gas concentration detected by a passive sampler, the method comprising:
illuminating an unexposed passive sampler with a light source;
measuring a first reflected light intensity;
illuminating an exposed passive sampler with a light source;
measuring a second reflected light intensity;
calculating percent light absorbance by the passive sampler based on the first reflected light intensity and the second reflected light intensity;
determining a gas concentration value by referring to a calibration curve; and
displaying a gas concentration value on a display.

11. The method of claim 10, further comprising:
detecting one or more of temperature, humidity and wind speed; and
compensating the percentage light absorbance calculation based on one or more of detected temperature, detected humidity and detected wind speed.

12. The method of claim 10, further comprising averaging a plurality of gas concentration values.

13. The method of claim 10, further comprising averaging eight gas concentration values.

14. A computer readable medium having stored therein a program for making a computer execute a gas concentration measurement method, said program including computer executable instructions for performing steps comprising:
illuminating an unexposed passive sampler with a light source;
measuring a first reflected light intensity;
illuminating an exposed passive sampler with a light source;
measuring a second reflected light intensity;
calculating percent light absorbance by the passive sampler based on the first reflected light intensity and the second reflected light intensity;
determining a gas concentration value by referring to a calibration curve; and
displaying a gas concentration value on a display.

15. The computer readable medium having stored therein a program as defined in claim 14, the program further comprising:
detecting one or more of temperature, humidity and wind speed; and
compensating the percentage light absorbance calculation based on one or more of detected temperature, detected humidity and detected wind speed.

16. The computer readable medium having stored therein a program as defined in claim 14, the program further comprising averaging a plurality of gas concentration values.

17. The computer readable medium having stored therein a program as defined in claim 14, the program further comprising averaging eight gas concentration values.

18. A system for measuring a gas concentration detected by a passive sampler, the system comprising:
means for illuminating a passive sampler;
means for detecting light reflected from the passive sampler and providing a detected light intensity signal;
means for detecting ambient temperature and providing a detected temperature signal;
means for detecting ambient humidity and providing a detected humidity signal;
means for detecting wind speed and providing a detected wind speed signal; and
means for calculating light absorbance by the passive sampler based on the detected light intensity signal and at least one of the detected temperature signal, detected humidity signal and detected wind speed signal.

19. The system for measuring a gas concentration of claim 18, further comprising:
means for determining a geographical location of the apparatus;
means for storing data related to detected light intensity, detected temperature, detected humidity, detected wind speed, geographical location; and
means for transmitting/receiving data to/from a remote location.
